(19) United States
(12) Patent Application Publication
(10) Pub. No.: US 2005/0106715 A1
(43) Pub. Date: May 19, 2005

(54) Device for utilization of organic waste material, particularly animal by-products

(76) Inventors: Andrzej Niv, Zabki (PL); Katarzyna Juchniewicz, Gasawa (PL)

Correspondence Address: NEIFELD IP LAW, PC, 4813-B EISENHOWER AVENUE, ALEXANDRIA, VA, 22304, US

(21) Appl. No.: 10/960,620

(22) Filed: Oct. 8, 2004

(30) Foreign Application Priority Data
Oct. 9, 2003 (PL) P-362728

(51) Int. Cl. C02F 3/02

(52) U.S. Cl. 435/290.3; 435/290.4

(57) ABSTRACT

The invention relates to a device for utilization of organic waste material, in particular animal by-products, comprising a cylindrical revolving insulated bioreactor with the continuous flow, placed on a frame, equipped with inwardly protruding internal manifold, temperature and moisture sensors and supported on rolling assemblies consisting of two casters. The device is characterized by the rotating bioreactor (3) placed on the rolling assemblies (20) supported on the support frame (6) and the support frame (6) is connected to the base frame (1) allowing its tilting. The base frame (1) rests on tensometric sensors (2) to measure the weight of the bioreactor (3) and the bioreactor (3) is driven in rotary manner around the stationary manifold (8) through which water and air are injected through each of the perforated paddles (10), by means of a crank shaft mechanism (13) connected to vessel heads (12) and (15) and a drive unit.

The invention relates to a device for utilization of organic waste material, in particular animal by-products such as slaughter plant waste material, animal mortalities, meat processing plant waste material, manure, stomach contents, sewage sludge and other waste material from meat processing plants and rendering plants, as well as distilled grain solids, fish waste material, dried or wet cow manure, swine manure, municipal sewage treatment plant sludge, agricultural waste material, catering waste material and many others.

Utilization of biological waste material, both of plant origin as well as animal origin, becomes an increasing problem along with the industrialization of food production.

Commonly, the utilization of high risk biological material is done by incineration process in special incinerators using gas, natural gas and heating oil which is very expensive and wasteful or by anaerobic fermentation to obtain methane—biogas, or composting in aerobic conditions.

The patent PL 164568 describes a device for producing thermally processed manure material, which includes insulated flow through kiln with a perforated drum revolving inside the insulation mantle of the kiln, the drum being equipped with axially and inwardly extending paddles, that move the material forwardly since the kiln is tilted towards the outlet. A plurality of gas or oil burners are located in the bottom of the kiln, which supply heat to the space between the insulation mantle and the outside surface of the drum. The heat penetrates through the perforation to the inside of the drum. The upper exhaust outlet is located in the middle of the kiln through which the combustion gases and large amounts of water vapor are emitted. The large portion of the water vapor is formed not only in the process of combustion but also is liberated from the manure or substrate, which is processed in the kiln. After heating, i.e., after the drying, the hot batch is transferred from the outlet end of the kiln to a different process stage. A temperature sensor is placed at the outlet end to measure the temperature in the range of 90-100° C.

This device is intended to process not only manure substrates but also clean, natural fertilizers and other materials.

The process of utilization of organic materials, in particular oiled knitting materials, synthetic yarn and wood shavings which are production waste materials, is known from PL 174223 the process basing on “coking”. The materials are shredded and mixed with liquefied coal and thus obtained plastic mass is cooled down, pelletized and added to coal for production of coke.

From the description of patent application PL 348385 a system for utilization of animal waste is known, which comprises a rotary reactor in form of a revolving cylinder, in which the batch, after shredding and sterilization in sterilizer using steam, achieves 150 deg. C. and is treated with calx. As the result of the reaction of calx with water the complete decay of the waste material occurs and the temperature increases in the range of 700-1200 deg. C. The temperature is regulated by the amount of water. The resulting calcium hydroxide is evacuated from the reactor to a chimney. The resulting lime is removed from the reactor and stored for 30 days to finish the cooling process and the cooled lime is used to deacidification of soil or production of organic fertilizer.

The aim of the invention is a device for utilization of organic waste material, in particular animal by-products, in which biofuel or compost for horticulture use is obtained without the need of any further processing or separating the products of the utilization process.

This objective is achieved by placing the revolving bioreactor on a plurality of rolling assemblies with elastic suspension on the support frame. The support frame is resting on the main frame with a hinge connecting the frames from one side to allow for tilting the upper frame in relation to the bottom frame. The bottom frame rests on several load cells to allow the measurement of the bioreactor mass. The bioreactor is attached to the vessel heads and driven to revolve around the long axis via the crank shaft mechanism to media manifold equipped with a plurality of air injection pipes penetrating down deep into the revolving biomass through which water and air are injected as needed.

The device is characterized in that every rolling caster assembly is resting on an air cushion with possibility to swing vertically up and down and around the axle of an arm, which is attached to the support frame. The cushions are interconnected hydraulically to allow for compensation of different pressures resulting from the inherent vessel shape imperfections. According to the invention, caster assembly consists of two metal casters with elastic synthetic polymer runners, positioned one above the other on spigots with polymer bushings bearing, swinging on a spigot at the end of the arm with air cushion between the free end of the arm and the frame. Another characteristic feature of the invention is that the outside pipe is revolving around stationary internal manifold connected by crank shaft mechanism to the vessel head(s).

The device is also characterized by the upper frame being tilted in relation to the horizontal bottom frame by the means of hydraulic cylinders.

The bioreactor is characterized by the heat exchanger for heating the incoming air, which is connected to the exhaust air coming from one or both of the vessel heads. The device is also characterized by the logical division of the internal space into three logical sections equipped with separate temperature and moisture sensors and each having its own running tracks lying on its caster assembly.

The device is also characterized by the installed temperature, moisture, oxygen, carbon dioxide and ammonia sensors, load cells and proximity sensors, equipped with preferably electric drive, air heater and air pumps being connected to electronic control panel and electrical panel which control the process of utilization of the organic waste material.

The advantage of the invention is totally safe, full utilization of burdensome waste material and conversion of the waste material into a free flowing biomass, which is used as biofuel, fertilizer or soil amendment. Thus obtained final product is chemically stable, hygienic, safe, and uniform and smells like the forest duff.

Only few by-products can be left in place of production without the need of difficult and hazardous transport to the place of utilization. The process of the invention is quick and takes only 3-6 days and can be carried out on the site of the waste material production thus catching the pollution at source. The waste material is isolated from the environment from the moment it is placed in the bioreactor till the end of the process and its unpleasant smell vanishes just within few hours from the moment the reaction starts. Since the bioreactor is a closed vessel, there is no possibility of turning back or omitting the waste flow. The parameters of the bioreactor, temperature, moisture, oxygen, carbon dioxide, ammonia, weight of the mass and time are recorded continuously and registered in the memory of the PLC without possibility of altering. The electronic scales built within the device allow for quantitative balancing the incoming as well as the produced material. Simultaneously it is assured that the biomass in the reactor is subject to the thermal regimen as specified by the EU regulation 1774/2002

Since no chemicals, elevated pressure or high temperature are used, the device makes the process to be totally safe and environmentally friendly. It has to be stressed that the odor from the byproducts completely vanishes after few hours of operation and the exhaust heat is captured via the heat exchanger so it can be used to heat the incoming cold air, thus preventing thermal losses and increasing the degree of reaction control.

The great advantage is the lack of any drainage, leakage or sewage which would require further treatment. Thanks to locating the cylinder of the bioreactor on the caster assemblies, attached loosely on the swinging joint leaning on the hydraulically adjusted air or hydraulic cushions on the upper frame, geometrical and mechanical stability of the vessel body is achieved. This allows lightening the reactor wall plate, which in turn considerably lowers the manufacture cost. The elastic caster assembly according to the invention can be employed to support revolving drums in other industrial applications.

The invention will now be described by way of example only with reference to the accompanying drawing, in which:

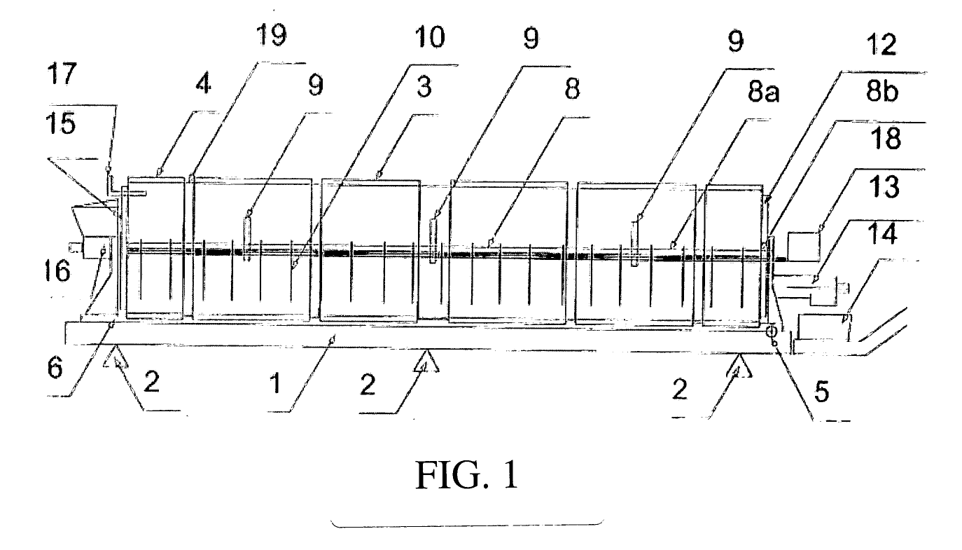

FIG. 1 shows schematically a side view of the device according to the present invention, partially in section, in a horizontal position;

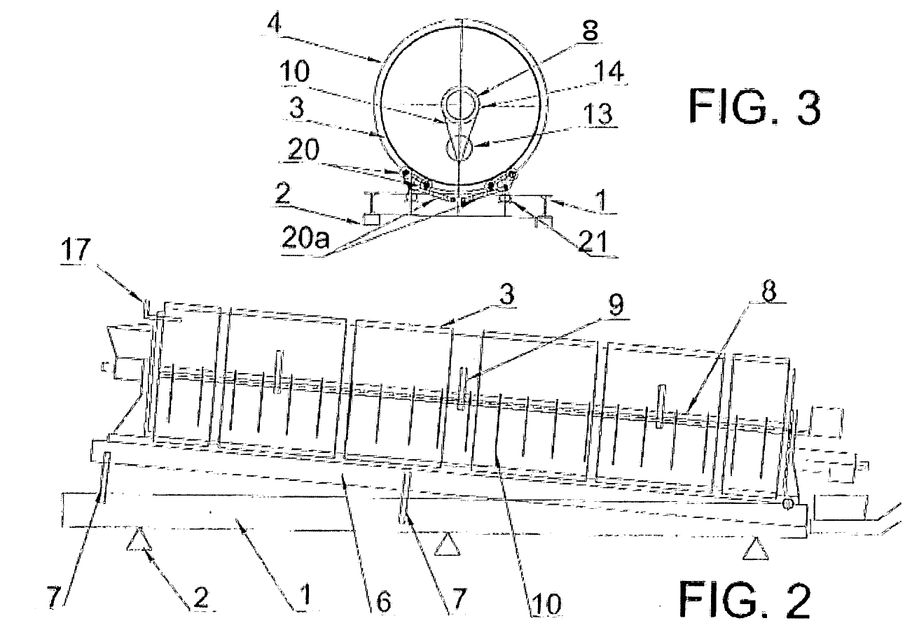

FIG. 2 shows the device from FIG. 1 in tilted position; and

FIG. 3 shows the device from FIG. 1 seen from the front of the outlet end.

The device shown in FIGS. 1-3 has the base frame (1) made from steel beams or profiles and has the shape of a rectangle. A pair of load cells (2) are installed below every longitudinal beam, which measure the weight of the vessel (3), which has the shape of a revolving cylinder covered with insulation mantle (4) and positioned on the tiltable support frame (6) and connected to the base frame (1) via the pivot (5). To tilt the support frame (6) with the reactor (3) around the pivot (5) to the angle of 5 degrees (or more) in relation to horizontal, at least 2 actuators/hydraulic cylinders (7) are used, preferably four. Of course, the number of the actuators used depends on the length of the reactor (3).

As seen in FIG. 1, the bioreactor (3) is divided into 3 logical sections having separate temperature and moisture sensors and is revolving around the stationary manifold (8). The manifold (8) is equipped with a plurality of vertical paddles (10) along the entire length of the manifold (8). The manifold (8) is comprised of the external pipe (8a) and the eccentrically placed internal pipe (8b) through which the water and air are supplied. The internal pipe (8b) is connected with each of the paddles (10) in which air and water orifices (11) are found and marked. From the intake side the bioreactor (3) is closed by the vessel heads (12) and (15). The crank shaft mechanism (13) is attached to the intake vessel head (12) and the outlet vessel head (15) to allow for vessel (3) revolutions without the revolving movement of the vessel heads (12) or (15). This allows for movement of the bioreactor (3) around the manifold (8) driven by (not shown) the drive, preferably electric or hydraulic. The manifold (8) and indeed its outer pipe (8a) and its inner pipe (8b), is protruding through the vessel head (12, 15) and various media like water, air and sensor cables are installed or connected to it. The outlet vessel head (12) is equipped with a discharge auger (13) or gate (13) pointing at the collection hopper (14). From the other end the intake vessel head (15) has the loading auger (16) with a hopper. The air exhaust pipe (17) is protruding from the vessel head (15), equipped with temperature, moisture, oxygen and carbon dioxide, and ammonia sensors. The exhaust air from the bioreactor (3) is evacuated through the exhaust pipe (17) and its temperature is 50-70 deg. C. This hot air is directed via the air duct to the heat exchanger (18), which serves to heat the incoming fresh air blown into the bioreactor (3). The bioreactor cylinder is equipped, at least in the intake and outlet sections, with trucks (19), which surround the vessel (3), and are supported on caster assemblies (20). Each caster assembly (20) consisting of 2 casters (20a), preferably equipped with polymer runners, for example made of polyurethane, is resting on the support frame (6) through the air/hydraulic cushion (21) and is able to tilt in two axles. Air/hydraulic cushions (21) are interconnected hydraulically.

The process is controlled by a process control unit (preferably PLC or a computer) to which all the sensors (9) and oxygen, carbon dioxide, ammonia and pressure sensors from (21), the drive units, valves and air pumps and load cells (2) to measure the weight of the bioreactor (3) are connected.

The process of the utilization according to the invention is conducted in such a manner that the biomass in form of animal by-products, offal, animal carcasses, meat processing waste material, food processing waste material, catering waste material, animal manure, municipal sewage sludge, industrial sludge, green waste material, organic fraction of municipal garbage, structural material like sawdust, wood shavings, wood chips, straw, grass, leaves or dried brewery solids or agricultural waste material and many other materials earlier shredded in a shredder are loaded into the vessel (3) after mixing. The amount loaded first is enough to fill ⅓ of vessel (3) capacity. After loading the vessel revolves at speed of 2 rev/hour and approx. 200 liters/minute of atmospheric air per tone of biomass is injected through the manifold (8), pipe (8b). After 5 hours the temperature of the batch rises naturally to approx. 30 degrees C. and more.

The conditions are kept for 24 hours, then additional ⅓ capacity batch is prepared in the same manner.

On the third and fourth day only ⅙ of the working capacity is added while the bioreactor electronic control panel takes over the manual operations of the device. The weight of the bioreactor, the temperature and moisture are continuously controlled and water content and the temperature are adjusted automatically.

On the fifth day the computer calculates the amount of the material that needs to be discharged in order to make space for ⅕^{th} of the working capacity. To perform the controlled automatic discharge the reactor is tilted by hydraulic pistons/actuators (7) to the angle of 5-7 deg off horizon and starts revolving at speed of 6-8 revolutions per hour. Discharge auger (14) starts turning or discharge gate (14) is open while discharge conveyor starts. This proceeds until the calculated amount of processed material is discharged. Then the auger (14) stops (or gate (14) closes), vessel (3) returns to horizontal position and revolutions of the vessel are reduced back to the speed before the discharge operation. Space for the new batch is ready at the intake vessel head of the reactor.

Thanks to such a procedure one can control the movement of the biomass material inside the vessel. In effect one gets steady amount of uniform biomass every day. Thus obtained biomass has the consistency similar to wet wood shavings or humus, it is homogeneous, hygienic and smells like forest duff.

Because of these qualities, thus obtained final product can be directly burnt (after predrying) as fuel in furnaces or kilns since its energetic value is 17-19 MJ/kg d.m. and amount of ash is between 2-18%. This feature has particular importance for industries producing large amounts of organic waste materials since they can save major energy costs by burning their own processed waste material as own home made biofuel. The ash from solely burning the of the product, when collected from furnaces is free flowing and can be used as mineral soil supplement since it contains mainly calcium phosphate and other minerals and microelements. This biofuel is environment friendly and certified.

Alternatively the end product can be used as organic fertilizer or soil amendment because its soil structure forming value is similar to peat moss and its fertilizer value exceeds that for peat moss many times since it contains chemically stable insoluble but available to plants nitrogen, phosphorus, potassium and multitude of microelements which are slowly released to plants and do not permeate to the ground waters or the atmosphere.

1. A device for utilization of organic waste material, in particular animal by-products, consisting of flow through, revolving, insulated bioreactor, suspended on a frame, equipped with internally positioned manifold with vertical paddles, temperature sensors, moisture sensors and supported on rolling assemblies consisting of two rolling casters, characterized in that the revolving bioreactor (3) is supported on a support frame (6) by the rolling assemblies (20), and the support frame (6) is tilting around pivot axle (5) in relation to a base frame (1), which rests on load cells (2) for weighing the bioreactor (3), the bioreactor (3) being driven in rotary manner around the stationary manifold (8) through which water and air are supplied via every protruding down paddle with orifice (10), by means of a crank shaft mechanism (13) connected to vessel heads (12) and (15) and a drive.

2. A device for utilization of organic waste material according to claim 1, in which every rolling assembly (20) rests on the frame (6) via a swing mechanism and is supported by air/hydraulic cushions (21) interconnected hydraulically.

3. A device for utilization of organic waste material according to claim 2, in which the air/hydraulic cushion (21) is connected with a pressure control duct.

4. A device for utilization of organic waste material according to claims 1 and 2, in which the rolling assembly (20) consists of two casters (20a) positioned one beside each other and equipped with elastic runners (20b) made from a suitable polymer material.

5. A device for utilization of organic waste material according to claim 1, in which the manifold (8) is composed of an external pipe (8a) and an eccentrically positioned internal pipe (8b).

6. A device for utilization of organic waste material according to claim 5, in which the internal pipe (8b) is connected with each of the perforated paddles (10).

7. A device for utilization of organic waste material according to claim 1, in which the support frame (6) is tiltably supported on the base frame (1) by means of actuators/hydraulic pistons (7).

8. A device for utilization of organic waste material according to claim 1, in which the bioreactor is equipped with a heat exchanger (18) to heat the air supply, connected to the air exhaust (17) placed in the vessel head (15).

9. A device for utilization of organic waste material according to claim 8, in which the bioreactor (3) is divided into at least three logical sections, each of them being equipped with its own sensors (9) for temperature and moisture measurement and equipped with circular tracks (19) for rolling assemblies (20).

10. A device for utilization of organic waste material according to claim 9, in which sensors (9), oxygen, carbon dioxide, ammonia and tensometric (load cells) sensors (2), a drive, preferably electric, air/hydraulic cushions (21) and air pumps are connected to the control panel which controls the process of the utilization of the organic material in the vessel (3).
